(19) United States
(12) Patent Application Publication
(10) Pub. No.: US 2003/0218374 A1
(43) Pub. Date: Nov. 27, 2003

(54) Off-highway off-road dump truck

(76) Inventor: Edward S. Kress, Brimfield, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/383,112

(22) Filed: Mar. 6, 2003

Related U.S. Application Data
(60) Provisional application No. 60/362,027, filed on Mar. 6, 2002.

(51) Int. Cl. B60P 1/04

(52) U.S. Cl. 298/22 P; 298/17 R

(57) ABSTRACT

A normally off-highway off-road dump truck is disclosed. The truck has a frame with a forward end and a rearward end. The rearward end of the frame is supported by at least two wheels coupled to part of the frame. The truck also has a forward strut support coupled to the frame near the forward end. The truck has at least first and second strut modules coupled to the forward strut support. The first and second strut modules each have an independent steering mechanism and at least one wheel and tire assembly. Each of the first and second strut modules can also have one or more motors for driving a respective wheel and tire assembly independent of each other wheel and tire assembly of that strut module and of the other strut module.

### FIELD OF THE INVENTION

The present invention relates generally to dump trucks, and more particularly to a fixed frame dump truck.

### BACKGROUND OF THE INVENTION

As technology becomes available, it is important to use the technology in the most efficient manner possible. Almost one-half century ago, components with better reliability and greater capacities became available for off-highway trucks. By using these components in the optimum configuration, what was believed to be the off-highway truck of the future was configured. Specifically, rather than having multiple engines, transmissions, axles, and tires for larger trucks, the number of engines and transmissions were reduced to one each, axles to two, and tires to six. Importantly, oleo-pneumatic suspensions were introduced at that time. These changes resulted in a compact, short wheelbase, light weight, but robust truck with improved maneuverability and ride characteristics. Today, the industry still considers this configuration to be ideal for now and for the foreseeable future.

Traditionally, fixed frame trucks use mechanical drive components which require the engine to be mechanically linked to a transmission, the transmission to be mechanically linked to the differential in the rear axle, the differential to then be mechanically linked to a planetary drive, and the planetary drive to be mechanically linked to the rear rims and tires. The rear tires in turn provide the driving force at the ground to move the truck. This method is used in virtually all highway passenger cars and trucks, and is used in most off-highway trucks up to around 200 tons. Off-highway trucks have now increased in capacity to 360 tons. About half of those trucks use mechanical drive components. The remaining half use electrical drive components.

In the last few years, larger trucks (300 tons and over) have reverted from Direct Current (DC) motors to a new technology that can effectively control the speed and torque of Alternating Current (AC) motors. Mechanical drive systems supply power over a wide speed range. DC systems supply power over a narrow speed range. AC systems can supply power over a wider speed range than DC systems, but not as wide a range as mechanical drive systems. However, because of their excellent reliability and simplicity, AC systems are an excellent choice.

The electrical drive vehicles now offered in the industry have the same location for the engine and alternator as a mechanical drive truck has for the engine and transmission. Two electric motors are normally located in the center of the rear axle in place of the mechanical drive differential and deliver power directly into the rear wheels through gear reducers. These prior art trucks still use the traditional two axle, six tire configuration having a single rear axle with two sets of dual tires for driving the truck. The front two tires are not driven and only steer the truck. They cannot steer sharply for a combination of reasons such as the overall width of the frame and wheel spacing is kept to a minimum, and in doing so, the frame that supports the engine and front suspension limit the turning capability. The configuration of the two axle, six tire trucks after almost fifty years of refinement is at the practical limit in size and efficiency.

Thirty years ago an oleo-pneumatic strut was developed for off-highway trucks which supported two tires, one on each side of the strut, through two connected spindles positioned one on each side of the strut. Among the many apparent advantages of this arrangement is the feature of tire separation. Dual tires which are on virtually all rear axles of this conventional construction are spaced very close together. Heat build up with these large, closely spaced tires is very serious. Radiant heat is transferred from one tire to another, limiting the performance of the tires and consequently the performance of the truck. With the tires on both sides of the strut, the spacing of the tires is about six times that of a conventional dual tire configuration. This additional spacing effectively eliminates this radiant heat problem.

In the past there have been two trucks built with common oscillating spindles. One spindle is located on the front, non-driving, steering axle with a strut between the tires. The other spindle is located on a rear, non-steering, drive axle with a motor between the tires driving the tires through a differential planetary gear set. In theory, oscillating spindles will allow the load to be equal on both tires. However, in practice this is only the case on a flat road with tires of equal diameter. Both of these prior art trucks require the pivot point of the oscillation to be well above the surface of the road. On uneven ground, the higher tire of the pair, of course, moves up. However, the higher tire contact point must also move out from the center line of the strut as the lower tire moves in. This movement shifts weight to the lower tire.

When turning, side or lateral forces are generated. Because the pivot point is located well above the ground, these side forces will shift additional weight to the outside tire. These lateral forces will either add or subtract to the load on the tire. The net result can put more load from the two sources on the lower tire and a side or lateral load on both tires.

On ground or roads that are fairly even, and when the truck is not turning fast, this is not typically a problem. However, when the ground becomes very uneven and/or when the truck is going fast around a corner, two undesirable conditions exist. First because there is structure between the tires on all of these vehicles, the spindle oscillation must be limited. A serious structural problem exists for all components when the spindle is at the limit of its oscillation. High vertical loads are imposed on the lower tire and high side loads are imposed on both tires. Side loads are the most damaging causing significant premature wear to drive components, bearings, structure, and the like. Second, when one tire blows out, very serious dynamic forces are generated on all structures and on the remaining tire.

With non-oscillating spindles, the only load increase between the tires occurs when an uneven ground surface deflects one tire more than the other. When a tire blows out with the non-oscillating spindle nothing serious takes place. The strut is substantial in design to easily handle the full load on one tire. The wheel bearings, if designed for 500,000 miles, will last for 50,000 miles under such conditions. Hopefully, the failed tire can be replaced within that length of time. Tire loading is only slightly greater between the tires of a strut with non-oscillating spindles on severely uneven surfaces than with dual tires on a conventional truck that encounter the same uneven surface.

Also, with a non-oscillating spindle the tire can be placed close to the strut. With an oscillating spindle, the tires must be spaced from the strut far enough to allow for the oscillation. This additional distance aggravates forces on the tire and forces generated when the oscillating spindle hits the oscillation limiting structure. In addition, the stability base of a non-oscillating spindle is at the outside tire. The stability base of an oscillating spindle is at the pivot point between the tires. Although this is much better than the stability base at the rear axle of conventional trucks it is not as good as either the front axle on conventional trucks or the non-oscillating spindle. In conclusion, there is no benefit to an oscillating spindle, only serious functional problems along with higher manufacturing and operating cost.

In recent years it was realized that there was a need for trucks to travel on unprepared surfaces, or off the road. As a result, an all terrain articulated, all wheel drive truck was developed, articulated slightly forward of the center of the truck. A drive line through the point of articulation powers the rear axle. Such trucks have become a standard in the construction industry, with their all-wheel drive mobility in soft off road conditions. In addition, all farmers know less fuel is used when the front tractor tires are driven. They pull when driven, when not driven they push. However, the industry generally has limited the capacity of these units to only 40 tons. This is only one-ninth the capacity of the conventional larger two axle trucks. The Russians, and an American truck manufacturing company, recognized the need to provide a large capacity all wheel drive truck. They have both developed a larger version of this articulated truck, but they did not make an impact on the industry. These trucks are no longer built because they lacked maneuverability, were too heavy, were unstable, and were costly to produce and operate. In addition, the configurations of these articulation trucks are fundamentally wrong. When cornering, weight shifts forward and to the side as the vehicle turns. To counteract these forces, the front outside tire should either stay in place or effectively move to the outside of the curve. With these articulated trucks, the front outside tire swings inward, the opposite of what is required, thereby reducing their stability.

These small all terrain articulated trucks are generally considered lighter duty than the standard fixed frame off-highway truck. Surprisingly, since they are lightly constructed, they have very poor payload to empty weight (P/W) ratios which are in the range of 1.05/1 to 1.2/1.

An empty truck must always travel in both directions, the payload in one, between the loading point and unloading point. To evaluate the cost of moving the truck versus the entire payload, the factor of 2(W/P), defined in greater detail herein, can be used.

The articulated truck with a P/W ratio of 1.12 will require $1.78 to move the truck for every $1.00 it takes to move the payload. The majority of current off-highway truck designs have a payload to weight ratio between 1.4 and 1.6. With P/W of 1.5, for every dollar to move the payload, it takes $1.33 to move the truck.

Conventional fixed frame trucks use limited stroke, non-compensated suspension which requires tires and structural members to absorb imposed dynamic and torsional stresses. This, in turn, requires the structural members to be heavy and, due to their configuration, prone to have areas of high stress concentrations.

In addition, there are other problems associated with many of these existing trucks. Conventional trucks have duel rear tires mounted on the same hub requiring both tires to turn at the same speed causing the dual tires to scrub when turning because each tire is a different distance from the point about which the truck turns. This requires each tire to rotate at a different rate which the tires cannot do because they are mounted on the same hub. These dual tires must also be precisely matched in size because they do rotate on the same hub. Otherwise there will be abnormal wear on the smaller tire because it must turn faster since it has a smaller radius. There is obviously less load on the smaller tire. The tire with the heavier load will not slip, so the smaller tire with less load must slip and will wear. The smaller tire will also wear faster and faster as it gets smaller over time. Also, with dual tires, the outer tire and rim must be removed to replace or access the inner tire.

### BRIEF DESCRIPTION OF THE DRAWINGS

FIG. 1 is a lower, front isometric view of a dump truck constructed in accordance with the teachings of the invention.

FIG. 2A is an upper, forward isometric view of the dump truck of FIG. 1 with the body up and the tires in a straight forward orientation.

FIG. 2B is an upper, forward isometric view of the dump truck of FIG. 1 with the body up and the tires at maximum turn.

FIG. 3 is a view similar to FIG. 2, but with the tires parallel at 90 degrees and the body dumping to the side relative to the direction of truck movement.

FIG. 4 is a rear view of the truck of FIG. 1.

FIG. 5 is a top view of the truck of FIG. 1 with the dump body shown only in phantom.

FIG. 6 is a side view in partial cross section of a strut module of the truck of FIG. 1.

FIG. 7 is an upper rear isometric view of one strut module of the truck shown in FIG. 1 and with one wheel removed.

FIG. 8A is an upper forward isometric view of the strut module with a motor and brake cooling air intake, motor controllers, motor controller radiator fan, fan motor, and braking grids.

FIG. 8B is an enlarged view of a portion of FIG. 8A taken from circle detail 8B.

FIG. 9 is a cross section from the top through the center of the lower strut, motor, and spindle showing air flow paths and components of the module assembly.

FIG. 10 shows the routing for all lines in position from a main suspension section of the truck to a movable and rotatable portion of the truck.

FIG. 10A shows all of the power lines of FIG. 10 with all other structure removed.

FIG. 10B shows the routing of the ground wire, temperature sensors and traction motor speed indicators shown in FIG. 9 and the fan and pump drive motor control wires shown in FIG. 7.

FIG. 10C shows the routing of the hydraulic lines for brakes and hydraulic motors of FIG. 8.

FIG. 10D shows the routing position of the various lines where a strut module is oriented in a nominal straight ahead orientation.

FIG. 10E shows the routing position of the various lines where a strut module is turned to a large angle of rotation.

FIGS. 11A-11F are each a schematic illustration of a possible steering mode of the truck of FIG. 1.

FIG. 12 is a forward, upper isometric view of another example of a truck constructed in accordance with the teachings of the present invention wherein only the front wheels are steerable.

FIGS. 13A and 13B are top plan views with the dump body illustrated in phantom of the truck shown in FIG. 12 and having a modified front wheel steering arrangement.

FIGS. 14A and 14B are top plan views of the truck shown in FIGS. 13A and 13B and having another modified front wheel steering arrangement.

FIGS. 15-17 are view of another example of a dump truck constructed in accordance with the teachings of the present invention.

FIGS. 18 and 19 are elevational perspective views of a strut and various line routing for the truck as shown in FIGS. 15-17.

### DETAILED DESCRIPTION OF THE PREFERRED EMBODIMENT

Examples of a dump truck constructed in accordance with the teachings of the present invention are shown and described herein. While the disclosed dump trucks can be used for on-pavement applications, they are particularly well suited for off-highway applications and even more so for off road applications. The disclosed trucks improve productivity, reduce cost, and have the ability to operate economically in the most adverse conditions. This allows a mine to operate more economically benefitting from more than just the reduced hauling costs. At least some tires are mounted independently, eliminating tire scrub when turning. Because the tires can be independently mounted and driven, these tires need not be precisely matched in size. The steering capability of the truck permits access to both the inner or the outer tire without removing the other tire of the set. By turning the tires well beyond 90 degrees as is permitted by the truck disclosed herein, all tires are easily accessible when appropriately turned and can be independently replaced either by removing or not removing the rim. The unique or novel truck configurations solve the previously discussed problems of conventional trucks and have many other features and advantages that will become apparent upon reviewing the description below.

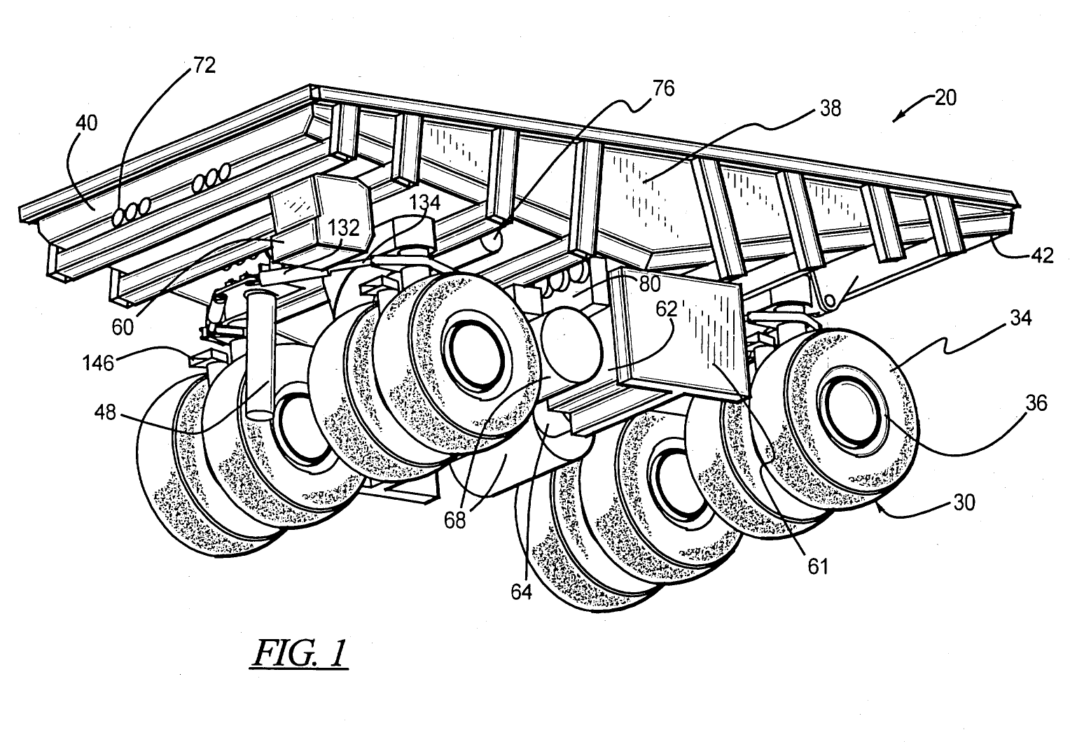

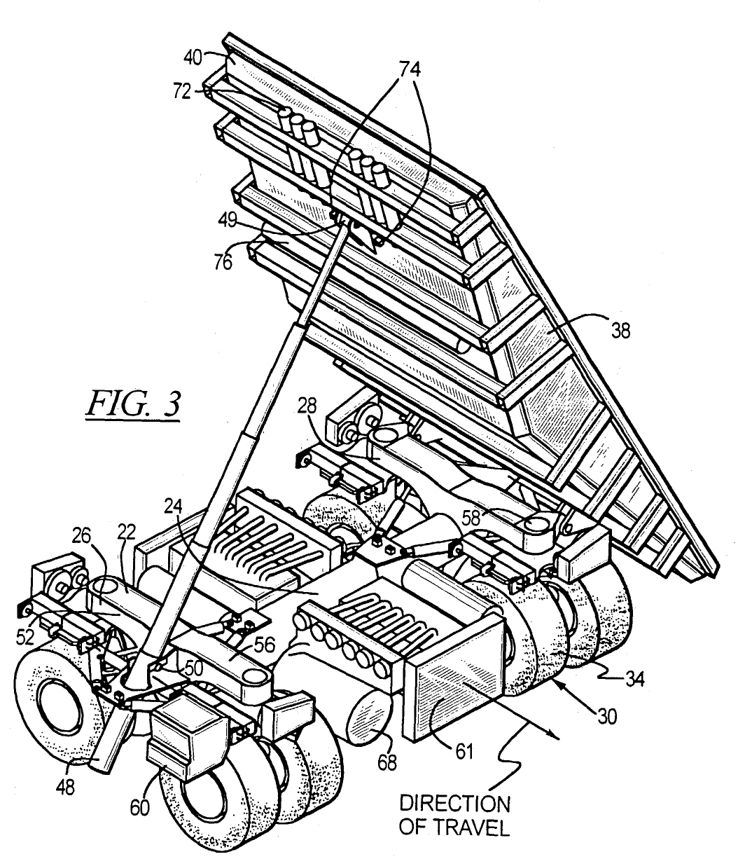

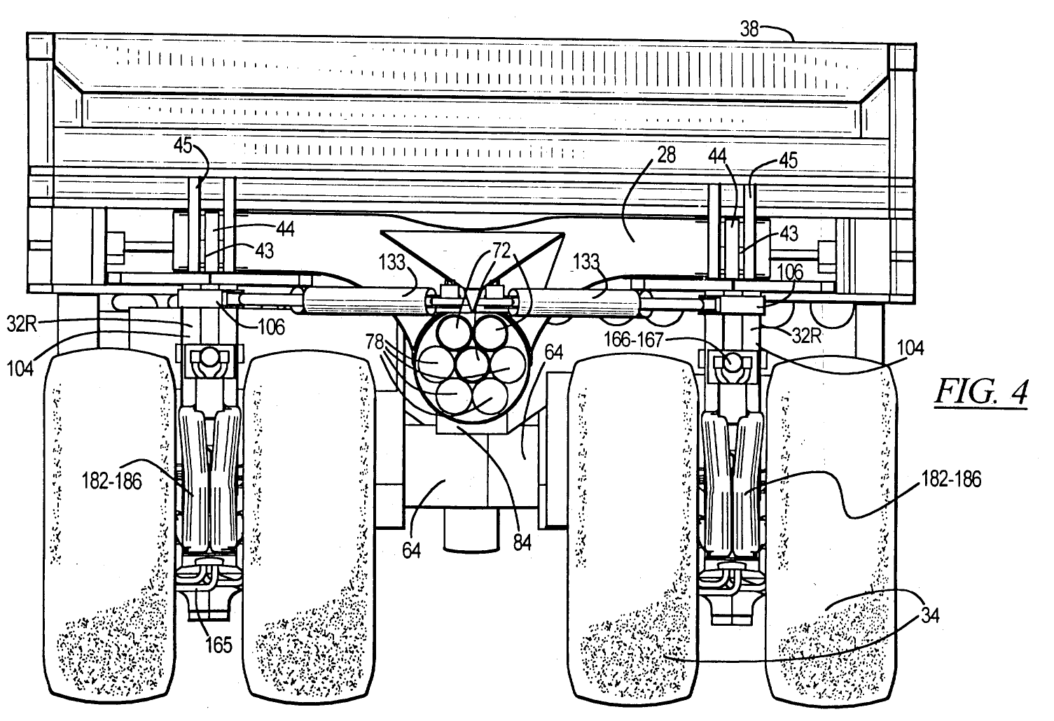

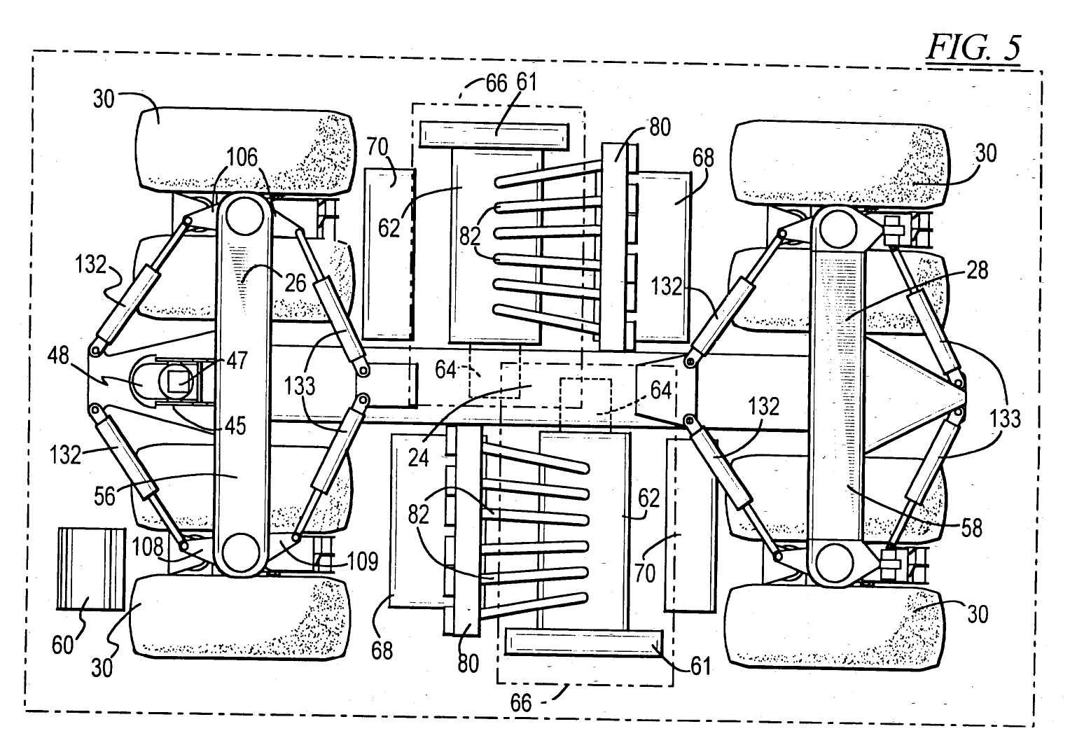

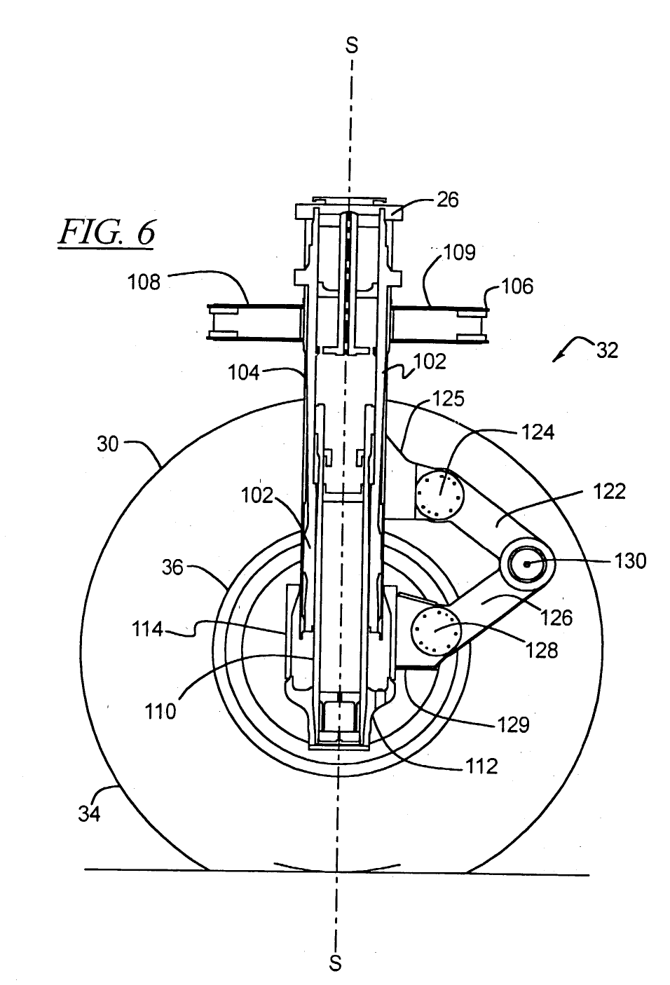

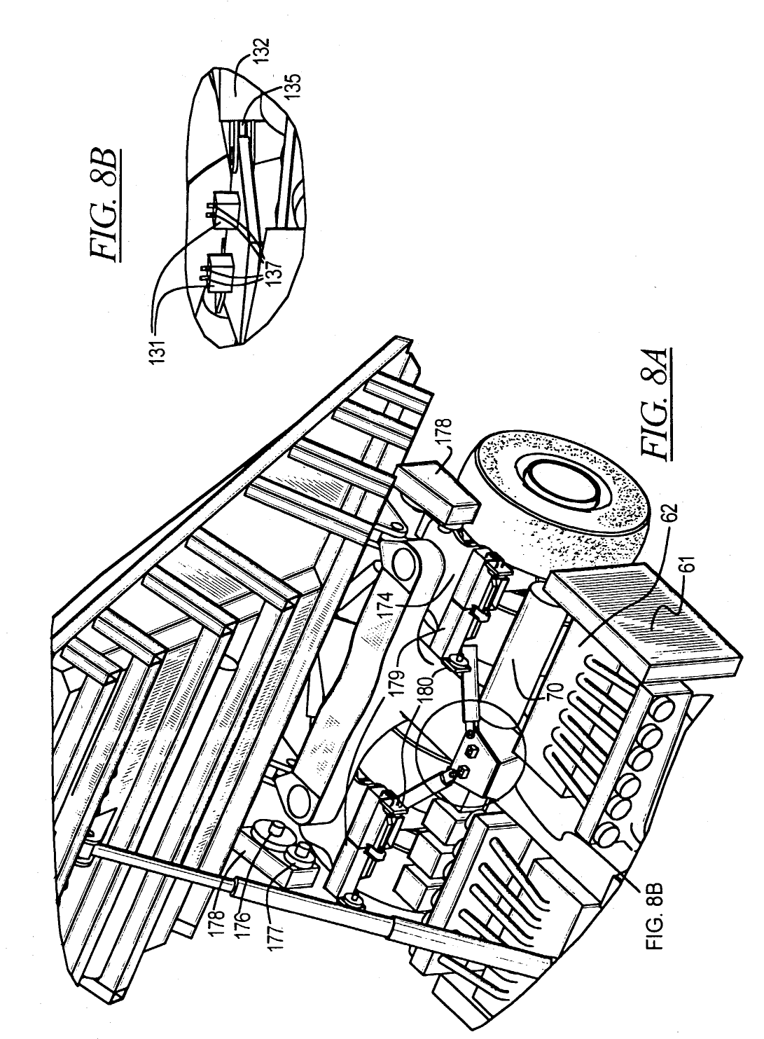

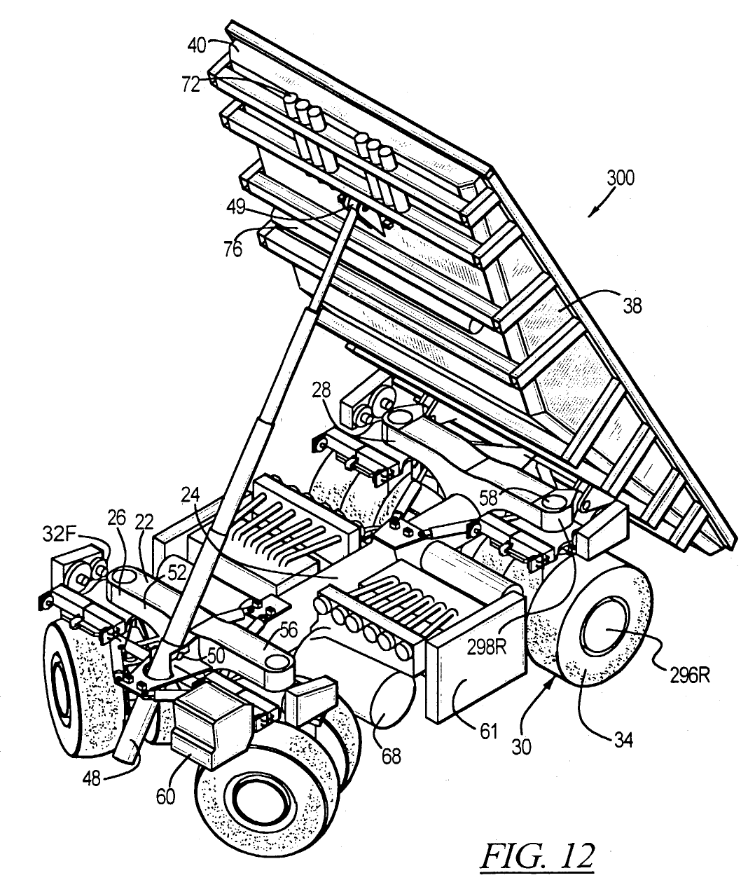

FIGS. 1-5, 8A, 8B, and 11A-11F show one example of a truck constructed in accordance with the teachings of the invention. FIGS. 12, 13A, 13B, 14A, and 14B show another examples of a truck. FIGS. 6, 7, 9, and 10-10F show one example of a strut module in accordance with the teachings of the present invention that is particularly useful on the trucks described herein.

Referring now to the drawings, FIGS. 1-5 generally illustrate a truck (20) constructed in accordance with the teachings of the invention. The truck (20) has a frame (22) with a center section (24) defining a longitudinal axis “A” of the truck. The frame (22) also has a forward transverse section (26) and a rear transverse section (28) connected with the center section and arranged generally perpendicular to the center section, whereby the frame (22) has an I-shaped configuration in plan view. The transverse sections each define strut supports for the truck (20), as defined in greater detail below.

The frame (22) is supported above a ground surface in this example on a number of wheel and tire assemblies (30). The wheel and tire assemblies are each mounted to one of a front or rear strut module (32F) and (32R), respectively, (simply (32) hereinafter if not referring to the forward or reverse modules specifically), described in greater detail below. The modules (32F) and (32R) are in turn mounted depending from the opposed ends of the forward and rear transverse frame sections (26) and (28), respectively. In the present example, each of four strut module (32) carries a pair of wheel and tire assemblies (30), thus totaling eight. Each of the eight wheel and tire assemblies (30) has one tire (34) mounted on a wheel rim (36) for rotation about a portion of the respective strut module (32).

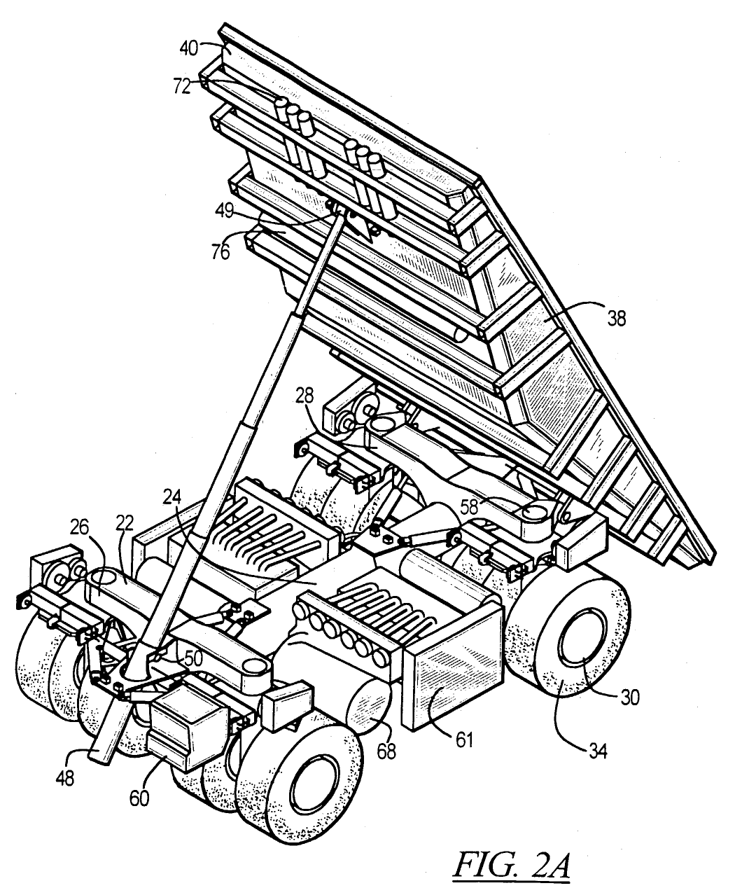

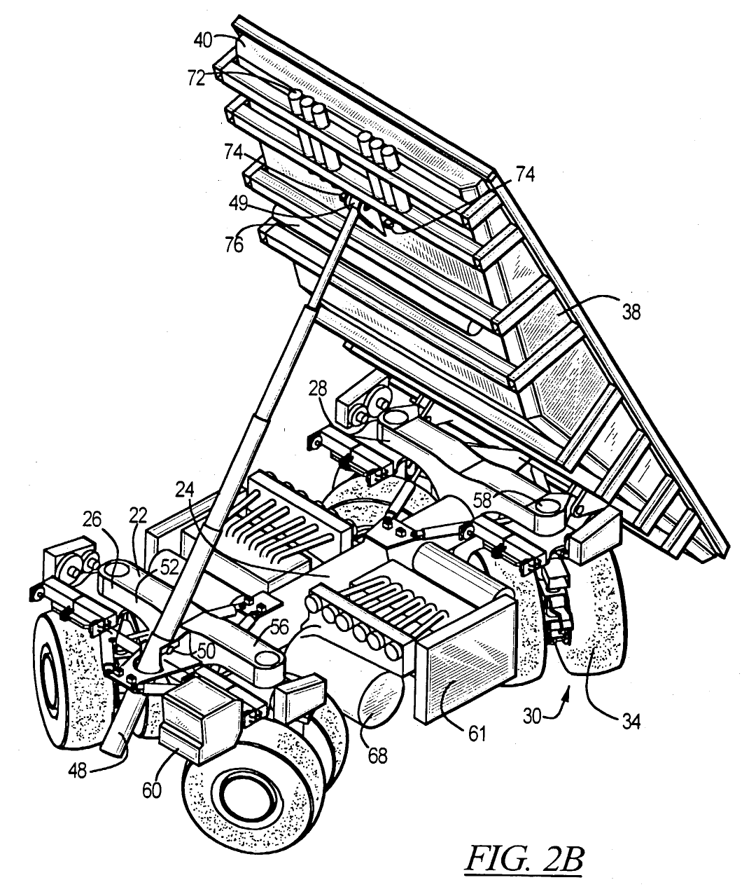

The truck (20) also has a dump body (38) pivotally mounted to a top portion of the frame (22). The dump body (38) is adapted to carry contents when in a lowered position (FIG. 1) and can be raised at a forward end (40) (FIG. 2) for dumping the contents. A rear end (42) of the dump body (38) has a pair of pivot structures (44) depending from its bottom surface (46). These pivot structures (44) are coupled to pivot structures (45) depending from the rear transverse frame section (28) on equidistant opposite sides of the frame center section (24).

To dump contents from the dump body (38), in one example the truck (20) has a single extendable cylinder (48) pivotally coupled at trunnions (50) to a forward part of the frame (22) along the center axis “A”. In this example, the trunnions (50) are carried centrally on a front facing surface (52) of the forward transverse frame section (26). The trunnions (50) are positioned forward of the end of the frame center section (24) and forward of the front wheel and tire assemblies (30), outside the turning or rotation envelope of the tires (34) generated by the rotation of the strut modules. The dump cylinder (48) has a second end pivotally coupled to the underside or bottom surface (46) of the dump body (38) nearer the forward end (40). When extended, the dump cylinder (48) raises the forward end (40) of the dump body (38) as shown in FIG. 2. Certain benefits are achieved by this configuration and are described in greater detail below when describing the operation of the various features and characteristics of the truck (20).

When loading the dump body (38) and transporting the contents, the dump body (38) rests on the top surfaces (56) and (58), respectively, of the transverse frame sections (26) and (28). This allows the body (38) and the frame (22) to work as one unit, each strengthening and supporting the other. There is effectively no load or bending moment on the frame sections (24), (26) and (28) of the truck (20) that are imposed by the dump body (38) itself or by the load or contents in the body (38).

The truck (20) also generally has a cab (60) that typically houses the controls for operating the truck (20). The cab (60) also typically houses suitable conveniences for the truck operator, though not shown, such as one or more seats, windows, environmental controls, doors, audio and communication devices, and the like. The cab (60) in the present example is positioned at one end of the frame (22) near the forward transverse frame section (26), and is supported by the frame (22) in an elevated position. The cab (60) can be located on either side of the truck (20) or in the middle above the axis “A”. In this example, the cab (60) is positioned somewhat forward of the front wheel and tire assemblies (30) and below or beneath the forward end (40) of the dump body (38). This position increases the visibility for the operator and will allow the operator to see the front wheel and tire assemblies (30) at all times, if necessary.

The central section (24) of the frame (22) interconnects the forward and rear transverse sections (26) and (28), and hence, the front strut or suspension modules (32F) to the rear strut modules (32R). The central frame section (24) in the present example contains one or more power modules (66) which can have radiators (61), engines (62), alternators (64), one or more fuel tanks (68) (such as for engine fuel), one or more hydraulic fluid tanks (70) (such as for brake fluid or other hydraulically actuated system fluid), as well as other auxiliary truck components.

It is very important that the load is dumped as quickly as possible to assure the maximum productivity of the truck (20). The high pressure oil to tip the dump body (38) enters through a rod end (47) of the multistage dump cylinder (48). The rod end (47) is connected near the front of the body (40). To reduce the hydraulic pump size and line size and length, and to assist in quickly lifting the dump body (38) and its contents, one or more hydraulic accumulators (72) are mounted to the underside (46) of the dump body (38) in close proximity to the dump cylinder (48). The accumulators (72) in this example are connected through two large dump valves (74) to assure adequate flow to the rod end of the dump cylinder (48) near the forward end of the center section (24) of the frame (22). An additional hydraulic tank (76) is in close proximity to the dump valves (74) to quickly receive oil from the dump cylinder (48) as the body (38) is lowered to the frame (22).

One convenient location for additional accumulators (72), to help power the dump cylinder (48), the steering cylinders (132), and the constant leveling of the struts (100), is inside the center section (24) of the frame (22). High pressure gas cylinders (78), normally nitrogen gas, can be located in this center section (24) to store the energy to power the accumulators throughout the truck (20). Alternatively, these gas cylinders (78) and accumulators (72) can be mounted virtually anywhere on the truck as desired. As the load increases on the truck, the gas in chambers (98) and (99) in the strut (100) compresses (See FIG. 6 and the description below) and oil from the accumulators (72) then flows into chamber (97) keeping the truck height constant in both the loaded and unloaded condition.

The configuration and arrangement of the I-shaped frame (22) and dump body (38) produces a decreased empty weight of the truck (20) as compared to prior known truck configurations. The frame (22) and body (38) configuration also yields the added benefit of having space for two additional tires (34) on each side on the front suspension modules (32F) of the truck as compared to only one tire per side on conventional truck designs. The configuration of the strut modules (32), described in greater detail below, also permits mounting the two additional tires (34) and rims (36) on the forward end of the truck at only a minimal increase in cost and weight. The additional cost and weight is only due to the other wheel and tire assembly (30). Due to the available space created by the truck (20) configuration, a second power module (66) can also be easily attached to the frame (22) vastly increasing the productivity of the truck (20). The close proximity of each tire to the strut is important to help reduce the overall width of the truck. The turning envelope of the tires on a strut is accommodated by the ample space beneath and between the frame components. The turning envelope of one strut must, however, clear the envelope of an adjacent strut to permit the large strut rotation angles

The frame (22) and body (38) configuration also conveniently allow for a wheelbase 50% longer than conventional trucks. As a result of the significantly longer wheelbase, the weight shift between axles is minimized while operating the truck (20). Less weight shift reduces both static and dynamic loads on the frame (22) and body structure (38). Less weight shift also reduces the load on the front tires (34) while cornering. It is an important feature that on the front of the truck (20) there are four tires (34), two on each side, to absorb the side forces and forward weight shift when turning.

Referring now to FIG. 6, a strut module (32) is generally shown in partial cross section with the outside wheel and tire assembly (30) removed. Each strut module (32), however, includes the two tires (34) in this example mounted on the respective rims (36) which are in turn carried on opposite sides of the strut (100). In the present example, the two spindles (142) are fixed to the strut rod (110) and do not oscillate.

Though described in greater detail below, each module (32) generally has a hydraulic strut assembly (100) which is attached above the tires (34) to a respective end of one of the transverse frame sections (26) or (28). One strut assembly (100) depends from each of the four corners of the truck (20). Each strut assembly (100) has a fixed strut housing (102) secured to and depending from its respective frame section (26) or (28). Each strut housing (102) defines a strut axis _S_ shown generally vertical in the present example when in the normal ride position. A steer tube (104) in the present example is arranged co-axially with and received over each strut housing (102) and is adapted for rotational movement relative to the respective housing (102). A steering link (106) is affixed near the upper end of each steer tube (104) and defines a plane generally perpendicular to the strut (100) axis “S_. As shown best in FIG. 5, each steering link (106) defines a pair of generally opposed steer arms (108) and (109). The. steer arms (108) and (109) are manipulated as described below to independently steer each of the strut modules (32).

Each strut assembly (100) also has a cylinder rod (110) telescopically received within the housing (102) that is slidable relative to the housing (102). The cylinder rod (110) is positioned at about its midpoint in vertical travel range relative to the housing (102) when in the normal ride position so that it can extend from the housing or retract into the housing as needed when traveling over varying terrain. A spindle housing (112) is affixed on the bottom end of the cylinder rod (110) and has a cylindrical wall portion (114) that surrounds the exterior surface of the steer tube (104) at its lower end. The spindle housing (112) can move vertically with the cylinder rod (110) and relative to the steer tube (104). The cylinder rod (110) and housing (102) operate as a conventional hydraulic strut (100) to cushion the load. Thus, the spindle housing (112) can move vertically relative to the respective frame section (26) or (28) for shock absorption.

A scissors link (120) has a first link arm (122) pivotally coupled at a first pivot joint (124) defined by a first bracket (125) affixed to the steer tube (104). The scissors link (120) also has a second link arm (126) pivotally coupled at a second pivot joint (128) defined by a second bracket (129) affixed to the spindle housing (112). The outer ends of the first (122) and second (126) link arms are coupled to one another at a third pivot joint (130). The pivot joints (124), (128) and (130) of the scissors link (120) permit the spindle housing (112) to move freely relative to the steer tube (104) and strut housing (102) along the strut axis _S_. Each component of the scissors link (130), however, is sturdily designed to prevent relative rotation between the steer tube (104) and spindle housing (112). Thus, as the steer tube (104) is rotated about the strut axis _S_ by movement of the steering link (106) as described below, the spindle housing (112) is also rotated to turn the wheel and tire assemblies (30).

As shown in FIGS. 2 and 5, each strut module (32) is steered independently by a pair of extendible hydraulic steer cylinders (132) and (133) each having one end pivotally connected to a respective one of the steer arms (108) and (109) of the steering link (106). The opposite ends of the steer cylinders (132) and (133) are pivotally coupled to bracket portions of the frame (22). Each steer cylinder (132) and (133) has an extendible rod (134) controlled by a steer cylinder control valve (131). A pressure indicator on each control valve (131) can be utilized via a computer (not shown) to coordinate steer cylinder pressure with wheel motor torque, as necessary.

Appropriate extension and retraction of the steer cylinders (132) and (133) of a particular strut module (32) will rotate the respective steer tube (104) about the strut housing (102) relative to the axis _S_ to turn the spindle housing (112), and hence, the wheel and tire assemblies (30). In one example, the tires (34) and wheels (36) of a particular module (32) can be steered more than 90 degrees, such as, for example, about 120 degrees or more in each direction, as shown in FIG. 2, from a nominal or rest position, as shown in FIG. 5.

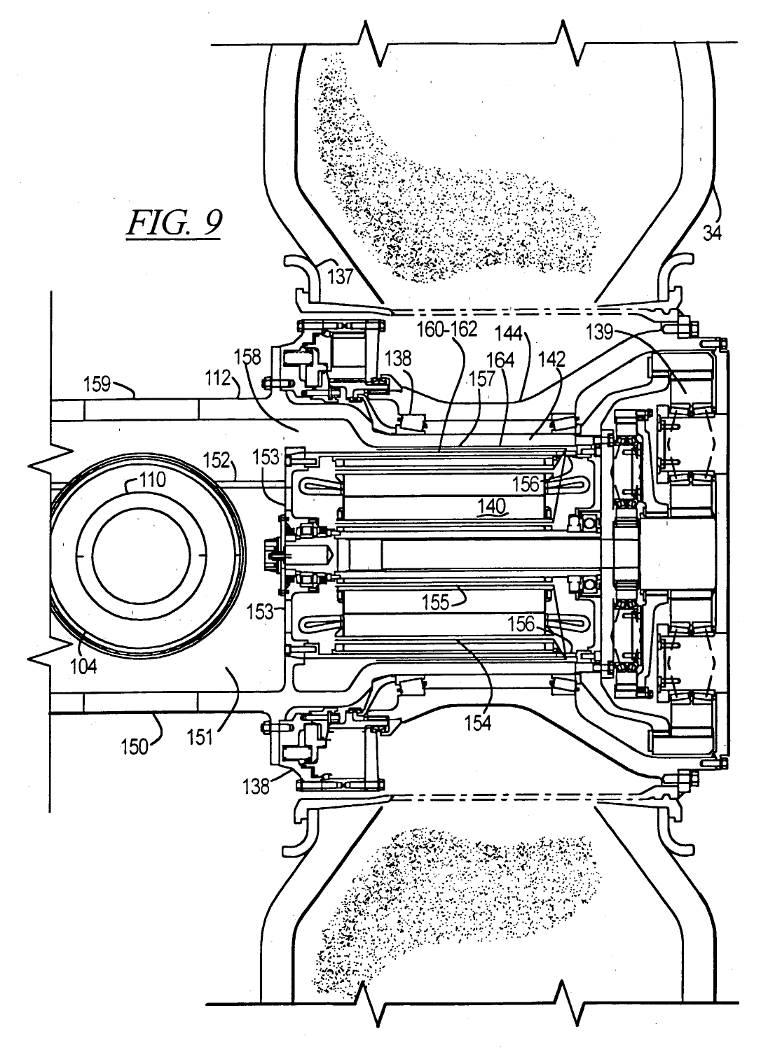

Referring to FIG. 9, each wheel and tire assembly (30) can be independently driven by a discrete motor (140) that is internally mounted inside a spindle (142) supporting each wheel rim (36). Each motor (140) is preferably an independently controlled electric AC drive motor (140). The motor (140) which derives its power from high speed must be combined with a speed reducer (139) to obtain high torque to produce the draw-bar required to propel a truck (20) of this type through soft ground and up steep hills. The truck (20) having high torque and the independent all wheel drive capability will give unique utility for the mining and construction industries. As shown in FIG. 9, each spindle (142) carries one motor (140) internally and supports two bearings (136) which, in turn, support a hub (144), which supports the speed reducer (139), a rim (36), and preferably one of the tires (34). Each spindle housing (112) has two spindles (142), one on each side connected to a central structure containing a hole, preferably a tapered hole, which accepts the strut rod (110). Each motor (140) drives only one of the two wheel and tire assemblies (30) of each strut module (32) and, therefore, each tire (34) can be driven independently, as necessary. The spindle (42) and hub (44) each support a section of a wheel brake (138), which, when actuated, restricts relative motion of the hub and spindle.

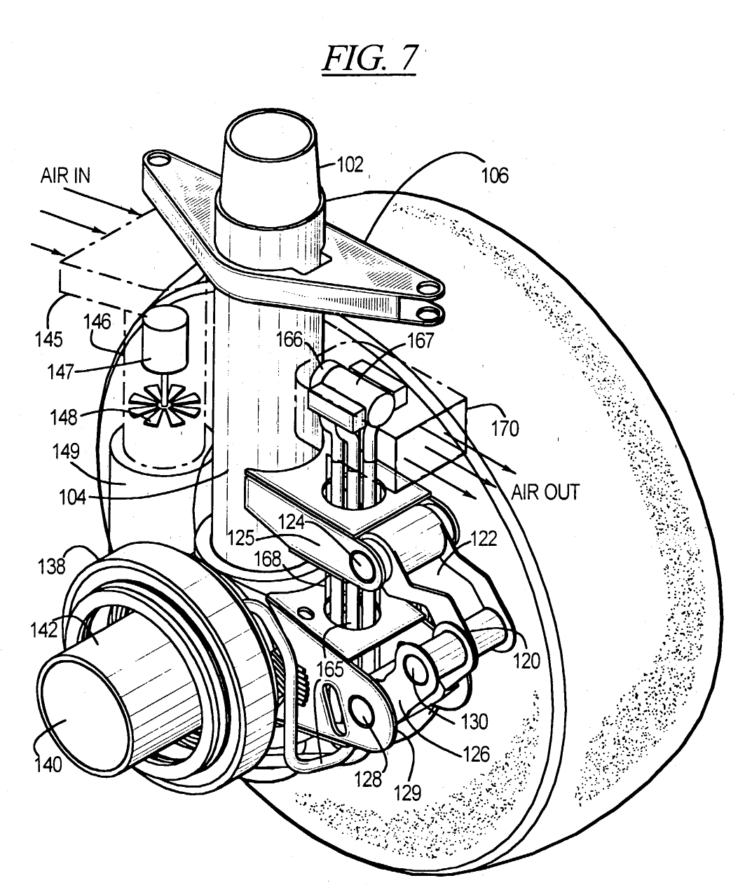

Each strut module (32) also has an air cooling system for the AC drive motor (140) utilizing air circulated through the spindle housing (112) and spindles (142). One example of the cooling system for each strut module (32) is shown in FIGS. 7-9 and simply described herein. Contained in the module (32) is an air inlet (145) positioned between the respective pair of tires (34) and, preferably, even with the top surface of the tires (34). This air inlet duct (146) contains a motor (147) which drives a fan (148) forcing cooling air through an air cleaner (149), positioned either before (upstream) or after (downstream) the fan, into the spindle housing (112) through an air inlet (150) into an inlet air chamber (151) divided by a plate (152) to separate the inlet air from the outlet air. Air then enters the motor (140) through holes (153) in the non drive end of the motor (140), then through holes (154) through the stator and holes (155) through the rotor. The air leaves the motor (140) through holes (156) in the motor housing (160). The air then travels back over the motor (140) through the gap (157) defined by the inside diameter of the spindle (142) and the outer diameter of the motor (140). The air then enters the outlet air chamber passing the plate (152) which separates the incoming air from the out going air. The air then exits the spindle housing through a hole (159).

In one example, the air that exits hole (159) after cooling the motor (140) passes through an exhaust duct (168). The exhaust duct (168) has one end coupled to the outlet opening (159) and an opposite end defining an exhaust opening (170) positioned between the respective tires (34) of the strut module (32) and again, preferably, even with the top surface of the tires (34). The air will flow from the outlet opening (159) through the exhaust duct (168) and exit the exhaust outlet (170). The position of the outlet (170) prevents the warm exhaust air from heating the inner surface of the tires (34).

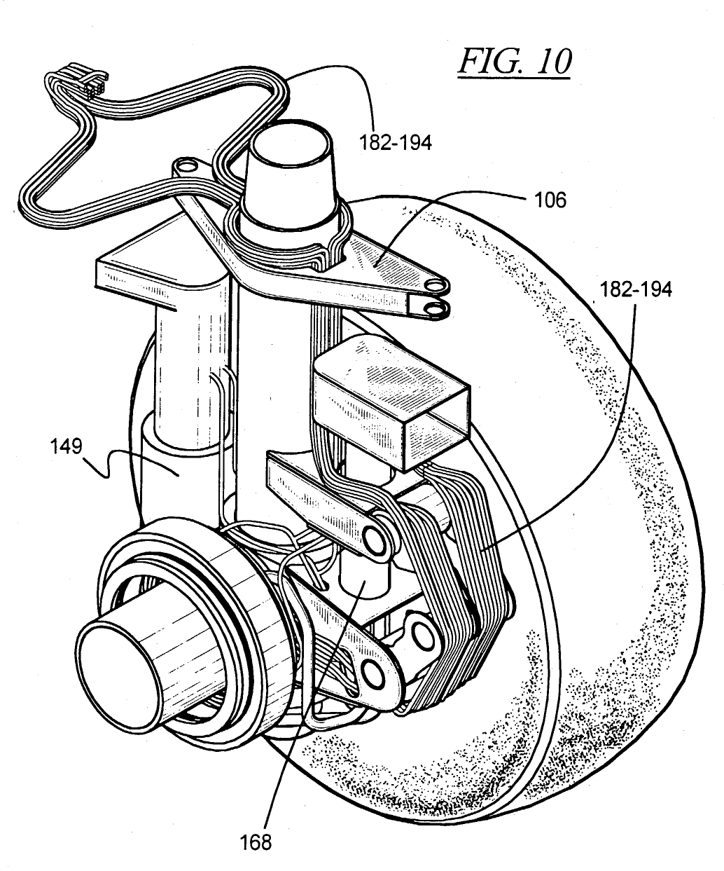

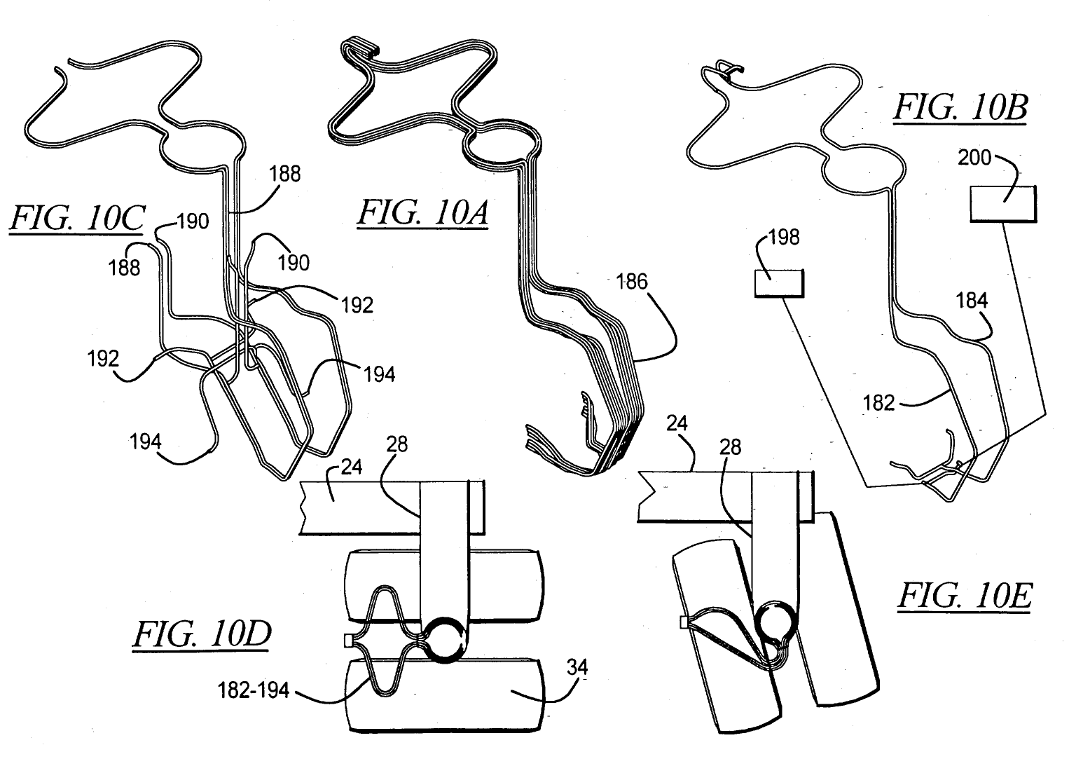

In a further example, the exhaust duct (168) can effectively become an oil cooler for a wet disc brake system (138). High volumes of air must be used to keep the motor (140) cool, therefore, the air leaving the motor (140) will be much cooler than the hot cooling oil leaving the brakes (138). The air can be circulated over the tubes (165) carrying the oil from the brakes (138) to the pumps (167), and back to the brakes (138) through the exhaust duct (168) oil cooler, cooling the oil and the brakes as required. The pumps (167) are driven by a motor (166) whose energy source can be high pressure oil from the accumulator (72) system that can be available on the truck. The inlet fan motor (147) of the air inlet duct (146) can also receive its supply power from the same accumulator line (190) shown in FIG. 10D. In summary, the disclosed strut construction allows the fan motor (147) and fan to circulate cooling air to the traction motors (140) and the oil cooled disc brakes (138).

In one example, the inlet air duct (146) can be affixed at the inlet opening (150) to the front of the spindle housing (112). The exhaust duct (168) can be affixed at the outlet opening (159) to the rear of the spindle housing (112). The exhaust duct (168) passes through the upper scissors link bracket (125) affixed to the steer tube (104) and is free to move up and down with the spindle housing (112) free of the steer tube (104). As shown in FIG. 10, the various hydraulic lines (172) for the fan motor (147) and the hydraulic lines for the parking (192) and service brakes (194) will be routed outside the scissors link (120).

Each strut module (32) is therefore composed of the strut (100), the various steering components, the spindle housing (112) and spindles (142), the wheel drive motors (140), speed reducers (139), the two brakes (138), and the cooling systems for the motors and the brakes. Also included in each strut module (32) are two hubs (144), two rims (36) and two tires (34). Each strut module (32) further includes the air flow cooling system, hydraulic and electric power cables, hydraulic lines to the brakes, and the motors to drive the cooling fan and the wet disc brake cooling oil pump. The strut module (32) construction and the frame (22) construction of the truck (20) produces a number advantages and benefits that are not available with conventional trucks of any size.

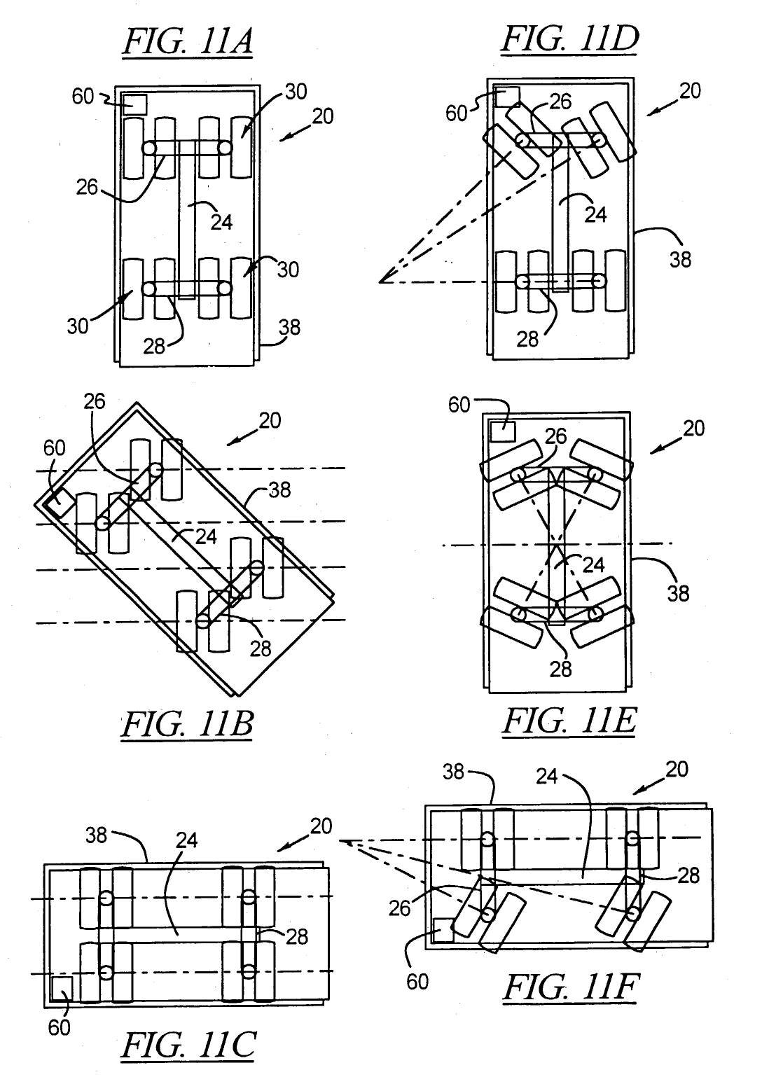

In one example, the steering link (106) and the two steer arms (108) and (109) are fixed to the steer tube (104) above the highest point of the tires (34) when the strut (100) is collapsed. With each of the steering cylinders (132) and (133) properly spaced and with adequate length of stroke, rotational angles well beyond 90 degrees can be attainable. In operation, each pair of the hydraulic steering cylinders (132) and (133) can turn the respective strut module (32) well above 120 degrees in each direction, for example, to achieve many different turning patterns for the truck (20) as exemplified in FIGS. 2 and 11A-11F. The wheels are always turning about a given common focal point unless when the vehicle is moving in a straight line.

By aligning the tires (34) of each strut module (32) as needed depending on the length and width of the truck (20) wheel base as shown in FIGS. 2 and 11E, the truck (20) can rotate about its center point while requiring only 45%, or less than half, of the turning area or radius of conventional trucks. The tires (34) can also be turned to any position while remaining parallel to one another as shown in FIGS. 11A-11C. Thus, the truck (20) can be driven in a straight line and yet the body (38) and frame (22) can be oriented at virtually any angle relative to the longitudinal axis _A_ of the truck. In addition, as shown in FIGS. 11D and 11F, any two strut modules (32) can be steered independent of the other two strut modules (32) and independent of each other to steer the truck (20) relative to any side or end, not just from the front end is with conventional trucks. Many benefits can be achieved by such steering flexibility. In addition, because each tire (34) on each strut module (32) is independently driven by its own motor (140), the two tires (34) on a module (32) can be driven at slightly different speeds, eliminating tire scrubbing when turning.

The truck (20) need be effectively no wider and no higher than a conventional truck, and yet can carry approximately twice the load and can weigh only slightly more than a conventional truck when empty. Conventional off-highway trucks must ride on relatively good, smooth surfaces in order to travel efficiently, such as on prepared mine roads. The truck (20) can travel efficiently on less than ideal surfaces and can travel up steeper grades because of its all wheel drive characteristics. These factors can significantly reduce the cost of hauling material and also can significantly contribute to reducing the cost of operating an entire mine.

In one example, the steering cylinders (132) and (133) can contain a linear displacement transducer to determine the axial position of each extended steer cylinder rod (134) to further determine the angle of the axis of the tires (34). An onboard computer (not shown) of the truck (20) can track this angle for each module (32) and will signal the appropriate controller of the other steering cylinders for the other modules (32). In this way, the rotated position about the strut axis _S_ can be controlled. For example, all tires (34) can be controlled to either roll on parallel wheel axes to move the truck (20) in a straight line, as shown in FIGS. 11A-11C. Alternatively, the wheel axes can be controlled so that they all intersect at a common point to provide a desired and proper radius as shown in FIGS. 11D-11F.

The modules (32) can be dynamically steered independently to maintain the common intersection point while turning and straightening the truck (20). This intersection point can be determined and controlled by a computer (not shown). The angle of the tires can be controlled in conjunction with linear displacement transducers (201) (see FIG. 12) integral with the steer cylinders (132) and (133). All tire (34) distances from this common intersection turning point will be known at all times, allowing the relative tire speeds to be controlled by the independent motor controllers (179). The tires (34) will then pull evenly, eliminating tire scrubbing while turning or traveling in a linear path.

As noted above, in one example, the intersection point can be moved to a position equal distance between the front and back modules (32F) and (32R), respectively, and to a point at the center of the truck (20) as shown in FIGS. 2 and 11E. In this steered configuration, the truck (20) can rotate about itself. Thus, the truck (20) can be turned around without moving forward or backing up in and within a very tight space. This is not possible with a conventional truck.

In another example exemplified in FIGS. 11A and 11C and as shown schematically in FIG. 3, the truck (20) can be positioned to dump contents from the body (38) either parallel to the truck axis _A_ or perpendicular to the axis _A_, as desired, or at some other angle as desired. This again can be done in very tight spaces without backing up the truck (20). This is done by rotating all strut modules (32) at the same rate so they remain along parallel wheel rotation axes _W_ as shown in FIGS. 11A-C. The tires (34) will always be going in a straight line but the truck body (38) will be rotating relative to the direction of travel. The truck (20) need not be backed up to alter the dump body (38) orientation relative to the dump point. Instead, the tires (34) can maintain the direction of travel as the dump body (38) rotates into position to dump the contents. This feature is particularly useful where the truck (20) must be positioned in a tight space to dump into a hopper or be positioned to dump over a bank. In summary, when at the loading shovel or at the dumping point, the truck (20) can move directly into position, and then drive away easily, reducing the time required to maneuver the truck (20) into and out of position for loading or dumping. Thus, the truck (20) effectively is both rear dump and a side dump truck.

Many in the mining industry have recognized the need for a side dump truck. A mining executive in the 1960's stated to the effect that “[t]he Lord must question our intelligence because we unnecessarily back up to dump a truck in the mines each year an equivalent distance equal to many times around the moon.” He could have doubled that distance if he realized that in many instances, a truck must also be backed up to the loading shovel as well, thus essentially doubling the backing distance. The backing distance for both loading and unloading can be eliminated utilizing the truck in accordance with the teachings of the invention. Also, the significant crew effort required for backing these extremely large vehicles is also eliminated. In addition, when at the loading shovel or the dumping point, the truck 20 can move directly into position, and then drive away easily, reducing the time required to maneuver the truck into and out of position for loading or dumping.

With all the rotation generated by the strut (100) when steering and the up and down motion of the strut (100) on uneven ground and poor roads, the routing of the electric cables (184) and (186) and the various hydraulics lines becomes very important. Slip rings for electric cables are very undesirable and swivel joints for hydraulic lines are impractical. The disclosed trucks solve these serious problems.

An enclosed chamber (174) is mounted forward of both the forward and rear transverse frame sections (26) and (28). Each is placed above the steer cylinders (132) and (133) and steer arms (108) and (109). Above each enclosed chamber (174), conveniently placed, is the respective AC traction motor control box (179). Through the rear section of this enclosed chamber (174), the steer tube (104) of the strut module (32) is placed. From the motor control box (179) through the enclosed chamber (174), in this example, are 12 electric power cables (175), one ground wire (184), and one hose containing small sensor and control wires (182). From the accumulators (72), four hydraulic lines (188-194) enter the chamber. One line (192) is for the parking brake, one line (194) is for the service brake, and one is a high pressure accumulator oil line (190) to power both the fan motor (147) and the motor (166) to power the brake pumps (167) that circulate the brake cooling oil. There is also one low pressure oil line (188) to return oil from these motor two motors (147) and (166) to the hydraulic tank. Two small valves (198) and (200) are also provided, one for controlling the fan motor speed as required and the other for controlling the braking pump motor speed as required.

In this example, these power cables (184), (186) and hoses (188-194) are routed directly to the required component in the lower unsprung components of the strut module (32). These cables (184), (186) and hoses (188-194), in this example, are clamped at one end to the enclosed chamber (174). They are all effectively the same length and are stacked three high and held together appropriately to stay in the same vertical plane and to minimize sag. They are in turn supported in a manner to prevent wear between the lower cables (184), (186) and hoses (188-194) and the floor of the enclosed chamber (174). Three of these stacks are loosely connected side by side. They are clamped to the steer tube (104) and are routed around the steer tube (104) down through the steer arm (108) and down over the steer tube (104) and looped appropriately to accommodate the full stroke of the strut (100). The scissors link (106) can help support the bundle as needed. Inside the enclosed chamber (174), nine wires and hoses are routed in two loops (197A and 197B) and looped appropriately to accommodate the rotation of the steer tube (104). Nine wires and hoses are routed in the two loops (197A and 197B) opposite to each other. It would be possible to stack nine or all eighteen of these wires and hoses vertically, but this would increase the height of the truck (20) and the center of gravity of the truck (20) unnecessarily which is undesirable

The efficiency of a large hauling truck (which relates to the cost of moving the payload) is proportional to the payload weight (P) relative to the empty vehicle weight (EVW). This is referred to as the payload to weight ratio P/EVW. In an effort to relate this to actual cost of moving a payload, one can multiply EVW times two, add the payload P, then divide this entire amount by the payload P:

(EVW*2+P)/P,

where this equation accounts for th fact that the vehicle moves in both directions to and from the loading point, whereas the payload moves in only one direction to the dumping point. This equation describes the amount of work the truck must do to complete one haulage cycle. Assuming that the payload is one or, P=1, the above equation becomes:

(2/P/W+1)/1.

This equation can be simplified to 2/(P/W). For P/W of 2.0, for every dollar it takes to move the payload, it takes $1 to move the truck. With P/W of 1.5, for every dollar to move the payload, it takes $1.33 to move the truck. The majority of current off-highway truck designs have a payload to weight ratio between 1.4 and 1.6. The disclosed trucks allow P/W ratios of over 2.3, resulting in less than 87 cents to move the truck for ever dollar required to move the payload.

A conventional truck with a two axle and short wheelbase configuration has four tires on the back and only two on the front. Although successful by present industry standards, it is not ideal due to variations in the center of gravity of the load (weight shifts forward when going down hill), and the dynamics of cornering. Under these conditions, front tires can experience high static and dynamic overloads. If a tire fails under these overload conditions, loss of control of the truck can easily result. The disclosed truck (20) can have a 60% longer wheelbase than some competitive trucks and will in turn use four tires (34) on the front axle. This configuration significantly reduces stress on the front tires (34) when under these adverse conditions. Additionally, if one tire (34) on a module (32) should fail, the remaining tire (34) can maintain control of the truck (20).

Another very important factor in the intrinsic value of a vehicle is its performance capability, which relates to the horsepower available to move a unit of material. There are two factors that can be used to compare vehicle performance and productivity. They are Horsepower (HP) per Gross Vehicle Weight (GVW) which is HP/GVW, and the horsepower that is moving the payload (PL), namely, HP×PL/GVW which is referred to as payload horsepower. With plenty of open space beneath the frame (22) of the truck (20) and with space between the strut modules (32F) and (32R), two of the largest conventional truck engines can be easily mounted to significantly increase the performance characteristics of the truck (20). The frame (22) and strut module (32) arrangement also provides unparalleled access to the power modules (66) for servicing and/or replacement. Payload horsepower of the disclosed truck (20) is approximately 2.4 times greater than the largest most productive conventional truck on the market today.

The major components for evaluating vehicle stability dependent upon the height of the center of gravity (CG) and the stability base (SB), or, in actuality, the square of the stability base (SB²). In most vehicles today, the stability base of the front axle is at the center of the front tires. This arrangement is good for stability, but bad for frame stresses and front tire loading. The stability of the rear axle is the point where the rear suspension effectively reacts at the center line of the rear axle. On most conventional trucks, the stability base between the front and rear axles is normally 5 times greater on the front axle. When this result is squared, the result is that the single front outside tire on the curve on conventional trucks effectively absorbs virtually all cornering side forces as well as the forward weight shift forces generated by cornering. The body is basically held from tipping over by the pins in the rear of the truck that the body pivots about when dumping and very slightly by the narrow frame. This conventional truck arrangement imposes high torsional stress on the narrow frame and overloads (during a turn) the single outside front tire to an extremely high degree. The disclosed truck (20) distributes the cornering forces equally to the four tires on side of the truck (20) that is on the outside of the curve. The long wheelbase minimizes the forward weight shift generated by cornering. This minimized weight shift is absorbed by two tires (34) rather than one tire on conventional trucks. One of the very important features of the disclosed trucks is that under all similar operating conditions the tires (34) will be under less stress not only reducing tire (34) cost but will allow the truck (20) to perform well at higher speeds and greater loads.

When dumping, conventional trucks locate their dump cylinders somewhere between the two axles requiring the cylinders to lift the entire weight of the body and the load. This load is transmitted directly into the frame. This location of the cylinders thus puts maximum stress on the frame. In the disclosed truck (20), the dump cylinder (48) is mounted to the frame (22) between the front strut modules (32F). Thus, the dump cylinder (48) is required to exert a force one half the weight of the body (38) and load. The other half of this weight is supported by the pivot pins (43) in the rear of the truck (20). The load is transmitted directly in to the strut modules (32F), and not between the front and rear modules (32R) along the truck axis _A_. This arrangement effectively eliminates bending stresses in the frame and reduces stress in the body (38) also allowing the frame (22) to be much more robust but much lighter relative to payload than frames of conventional trucks. FIG. 2 shows accumulators (72) that will help to greatly reduce the time required to dump the truck (20). The accumulators (72) are closely mounted to the dump cylinder (48) to improve the flow characteristics of the oil from the accumulators (72) to the dump cylinder (48). This arrangement allows the truck (20) to dump and return the body (38) in less than one half the time it takes to dump and return the body on conventional trucks dumping loads almost twice as large.

All conventional trucks must stop, change direction, and back up to a bank or a hopper to dump the load. However, this is dangerous for at least two reasons. First, the driver must be very attentive or he will back over the bank or into an object. Second, inertia force generated from the weight of the truck as the brakes are applied to stop at the edge of a bank can, on occasion, cause the bank to collapse.

This stopping, reversing, turning, backing up and stopping again is not only hard on the truck but is time consuming. This conventional procedure also takes place every time the truck backs under a shovel to get loaded and backs to a dumping site to unload. The disclosed truck (20) eliminates this unproductive, unsafe and wasteful maneuver completely at both ends of the haul cycle.

The disclosed dump truck (20) allows greater capacities, higher efficiencies, and improved maneuverability. In addition, all tires (34) can be driven and steered independently, allowing for superior mobility under poor hauling conditions. The disclosed truck (20) is a very rugged, very heavy duty and yet a very light weight truck relative to its capacity with remarkable performance features under the most adverse conditions. The disclosed truck (20) is a major step forward, not only in truck carrying capacity, but in every characteristic that the earth moving industry needs to both increase production and to reduce cost of moving material. Importantly, the disclosed truck can thus reduce the cost of operating a mine, construction site, or the like.

FIGS. 12, 13A, 13B, 14A, and 14B show in more detail simplified steering configurations to accomplish the steering mode shown in FIGS. 11A and 11D. For example, FIG. 12 shows a truck (300) constructed in accordance with the teachings of the invention. The disclosed truck (300) has only front strut modules (32F) as described above. The front wheel and tire assemblies (30) can be independently steered, as described previously, through large steering angles in each direction of, for example, 105, 110, or 120 degrees or more. However, the rear strut modules (298R) are held in one preferred example by fixed links and are not steerable. They remain in a straight forward orientation as shown at all times.

Either the front wheels, the rear wheels, or both can be powered or driven. If the front wheels are driven, one or more of the front wheel and tire assemblies (30), in one preferred example, can be driven independently by a discrete motor (140) as described above. However, all of the front wheels need not be driven. Similarly, if the rear wheels are driven, one or more of the rear wheels can be driven by a respective motor (140) as described above or the rear wheels can be driven in a conventional manner. In this front wheel steering configuration, it is preferable to power the rear wheels.

The rear strut modules (298R) can be mounted two per truck with one per side on either the front or the rear of the truck, or can be mounted four per truck. The rear strut modules (298R) and/or the rear wheel and tire assemblies (296R) can be mounted on conventional non-driven axles. The rear wheel and tire assemblies (296R) can alternatively be mounted on rear strut modules (298R) that are essentially the same as described above for modules (32R), except that they do not have steering mechanisms and do not turn. Each rear wheel and tire assembly can thus be driven independently by its own discrete motor at varying speeds as described above to avoid scrubbing when turning.

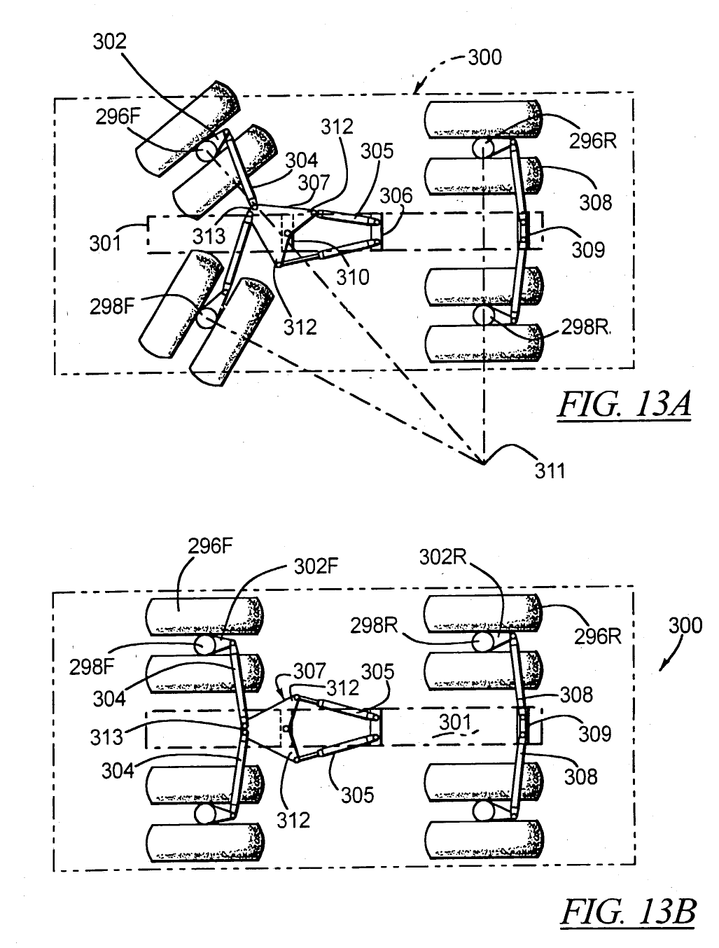

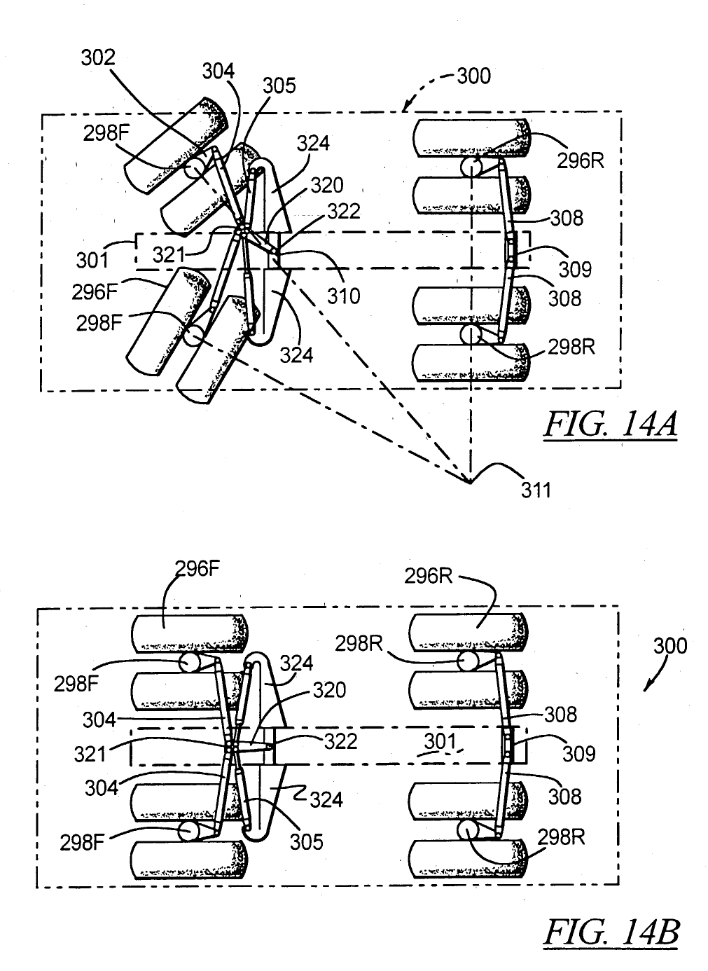

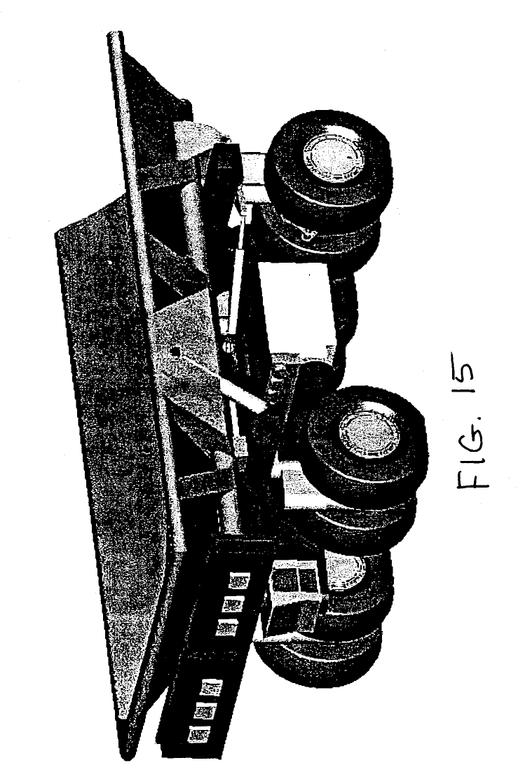

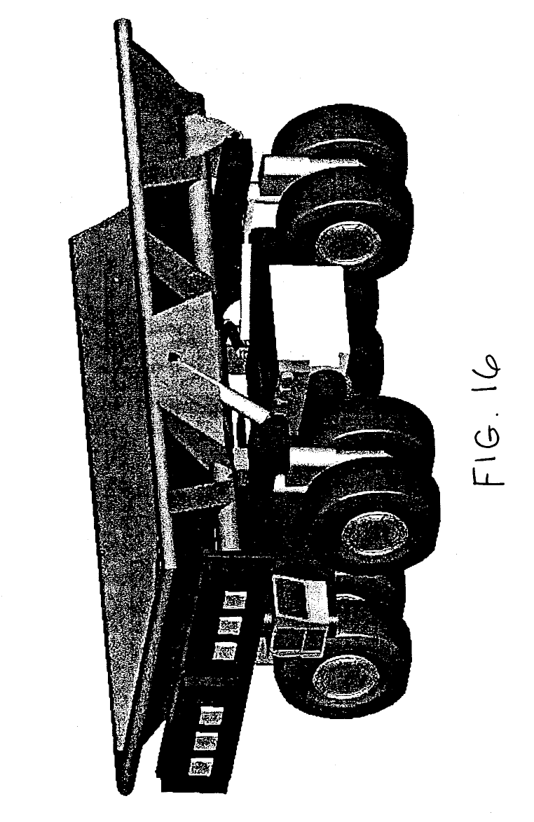

The truck (300) has what is known as an Ackerman steering geometry and steers similar to conventional cars and trucks, except for the additional benefits achieved by the front strut modules (32F) described above. FIGS. 13A, 13B, 14A, and 14B each illustrate the truck (300) with Ackerman type front wheel steering, but with alternative steering mechanisms and arrangements.

FIGS. 13A (front wheels turned) and 13B (front wheels straight) show the truck (300) with one alternative steering arrangement. In this disclosed example, the truck (300) has a frame (301) and front and rear strut modules (298F) and (298R), respectively, similar to the frame (22) and modules (32) described above, except for the differences discussed below.

Each strut module (298) has only a single link arm (302) extending rearward from the steer tube (104). The link arm (302F) of the front strut modules (298F) is utilized to steer the front struts. The link arm (302R) of the rear strut modules (298R) is used only to stabilize and hold the rear struts in a straight ahead orientation as shown. Thus, the rear link arms (302R) can be effectively affixed instead to the strut housing (102), (see FIG. 6), with the steer tubes eliminated, if desired.

A rigid, fixed length drag link (304) is connected to each front strut link arm (302F) at one end. A pair of steer cylinders (305) are provided, each pivotally coupled at one end to a cylinder bracket (306) mounted on a portion of the frame (301) rearward of the front struts (298F). The opposite end of each drag link (304) is connected to a triangular shaped whiffletree bracket (307) that is pivotally supported on a mounting bracket (310) affixed to a portion of the frame (301) forward of the cylinder bracket (306). The whiffletree bracket has a pair of opposed, laterally extending steer arms (312), each pivotally coupled to an opposite end of a respective one of the steer cylinders (305). The whiffletree bracket (307) also has a forward end (313) pivotally coupled to the opposite ends of the drag links (304).

The rear link arms (302R) of the strut modules (298R) are each connected to one end of a corresponding stationary link (308). Each link (308) also has a second end coupled to a mounting bracket (309) attached to a portion of the frame (301). The stationary links (308) hold the rear strut modules (298R) and rear wheel and tire assemblies (296R) in the straight ahead orientation as shown.

FIG. 13A shows front strut modules (298F) with the front wheels in a turned orientation and FIG. 13B shows the front strut modules (298F) with the front wheels in a straight ahead orientation. For an Ackerman geometry, each wheel and tire assembly (298) has a rotation axis that is positioned theoretically to intersect at all steer angles at a common point (311) on the center line of the rear axle. This means that the front wheel and tire assemblies (298F) are each turned to a different angle or degree as shown. As before, the steer cylinders (305) can be, but need not be, controlled by an on-board computer (not shown) for accurate positioning since they are mechanically linked.

In this example, the cylinders (305) can be automatically length adjusted to pivot the whiffletree bracket, which in turn moves the forward end (313) from side to side. This movement in turn moves the drag links (304) to turn the front wheel and tire assemblies (298F) as desired via the front link arms (302F).

Many possible steering mechanism configurations and constructions can be utilized for the truck (300). Further, many different steering geometries can also be used.

FIGS. 14A and 14B show one of many possible alternative steering geometries and component configurations. In this example, the steer cylinders (305) are positioned forward of an alternative whiffletree bracket (320) having a pivoting end (321) and a forward end (322). A pair of opposed and laterally extending cylinder support brackets (324) extend from the frame (301) and are each pivotally coupled to one end of a respective cylinder (305). The cylinder opposite ends and the drag links (304) are each coupled to the whiffletree bracket (320) near the forward end (321). In this example, extension and retraction of the cylinders (305) pivots the whiffletree bracket side to side about the pivot end (322), moving the drag links (304) and, thus, turning the front strut modules (296F) and front wheel and tire assemblies (298F).

The truck (300) in each example disclosed herein can be less expensive than the truck (20), and yet provide nearly all the benefits. Each truck (300) would not be able to be driven perpendicular to its own axis, but the turning ability would be similar to Ackerman steering geometry used in conventional cars and trucks, except that the truck (300) of FIG. 12 will permit turning of the vehicle about a point at approximately the center of the rear axle.

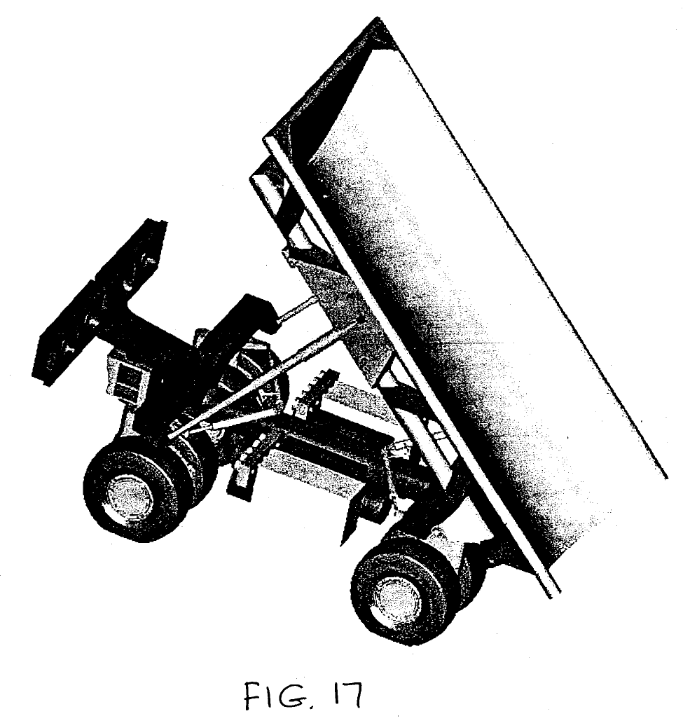

FIGS. 15-18 illustrate another alternative example of a truck constructed in accordance with the teachings of the present invention. In one example, the cab can be relocated to the center line of the truck as shown in FIG. 15, and can be forward of the front transverse fame section. The cab in this example is also positioned forward of the main center section of the frame assembly and under or beneath an extension of that structure. The extension provides rollover protection for the cab and occupants or operators of the truck.

The extension also provides added structure to support the truck radiators mounted forward and above the cab. This is a new and ideal location for the radiators. The radiators can receive clean air and are protected by a forward section of the body. The unique configuration of the trucks disclosed herein, and particularly, the location of the basic truck components makes these advantages possible.

The center location of the cab described above also results in unequaled visibility fo this type of truck. One of the many features of the disclosed truck configurations is many different modes of steering are possible. In one mode described above, all tires can be turned and yet remain oriented parallel to each other. This allows the truck to move in a straight line and yet at an angle relative to a straight forward direction.

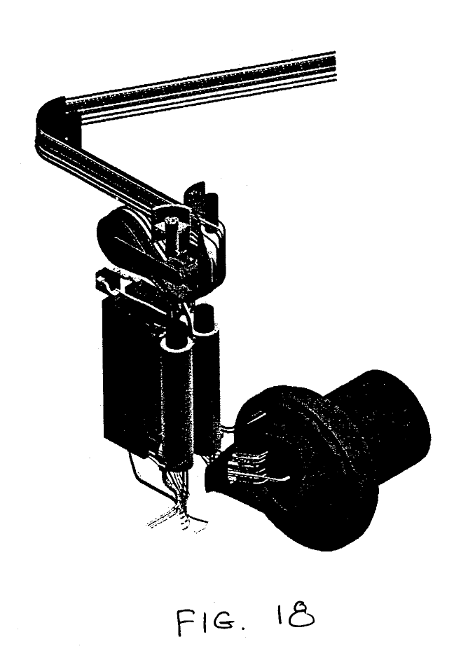

When all the tires are turned ninety degrees to the body and oriented parallel to each other, the truck can move sideways and yet in a straight line, as shown in FIG. 16. This can produce a time and space saving advantage when spotting the truck under a shovel and when dumping. In both cases, wear and tear on the truck and the various drive and power components is reduced because the actions of stopping, backing up or turning, and stopping again can be eliminated. By positioning the cab centrally as described above in this example, the operator has much improved visibility, regardless of the direction of travel for the truck. To further enhance operator visibility, the cab can be mounted and constructed to rotate in concert with the tires in this mode of steering, also as shown in IG. 16. This will allow the truck operator to always face forward in the direction of travel.

The one or more power modules, each including at least an engine and an alternator, are positioned one on each side of the main center structure or the frame in this example. The power modules are supported and enclosed in a structure that is supported by the main center section of the frame. The outer face of the power module enclosure can swing open to allow unlimited access for maintenance of the modules. On the inside of the module enclosures, plenty of space can be provided for free access to and around the power module components. A vehicle that can be used to lift, remove, and replace the power modules can have unlimited assess to the enclosures and to the components within the modules.

As in the previous examples, the lateral or forward and rear transverse sections of the frame assembly extend transversely relative to the main center section of the truck frame. The transverse sections, and thus the truck, are supported by four strut modules, one positioned at each comer of the truck. The strut modules, as in the previously described examples, each include a strut, one or more spindles, and one or more tires. The front transverse frame section in this example extends out beyond a taper mount or the strut. In this example, a pair of multi-stage dump cylinders are utilized to raise and lower the dump body as shown in FIG. 17. Each end of the front transverse section supports a multi-stage dump cylinder, one on each side of the truck.

There are multiple advantages to the arrangement of the above described dump cylinders, whether utilizing the single cylinder described above or the dual cylinder construction, in comparison to conventional trucks. Conventional trucks typically utilize a single cylinder positioned along the truck center line and located at or behind the center of gravity and close to the ground. In addition, conventional cylinder arrangements are remote from the truck suspension components, causing high stresses throughout the length of the frame.

With this disclosed truck, the dual dump cylinders are effectively mounted at the strut. This positioning greatly minimizes stresses in the frame and body structures, because the dumping forces are transmitted directly through the dump cylinder, through the strut and spindle, and onto the tires. The forces transmitted in the cylinder and on the body are also minimized because they are transmitted well forward of the center of gravity of the load. The cylinders are also mounted on the deep side sections of the transverse sections where they are the strongest. In addition, the very wide spacing and high mounting position of the cylinders stabilize the body on uneven ground and when carrying uneven loads. Further, the dump cylinders are well protected and are easily accessible for maintenance.

The floor of the dump body of this new truck can be seen in FIG. 17 and is designed to act like a catenary. A catenary is a sagging cable connected at opposite ends. Such a construction insures that there can only be tension applied throughout its length. There is no possibility of having bending stresses in the body of floor. The floor of the dump body in this new truck is only connected at its side edges to the top outside tube of the body. When a load is placed in the dump body, the floor of the body is free of any framing or bolsters. Thus, there are no bolsters to impose bending stresses, nor are there any points where stress concentrations are generated in the floor.

To illustrate, the upper outside tubes on this body where the floor plate will be attached are spaced, for example, about thirty feet wide. The normal cross section load on such a body floor, assuming a one inch wide section of the floor traversing the dump body for these calculations, will weigh about 2200 pounds. The weight supported at each side of the dump body would only be about 1100 pounds. If the floor has an arc that is 36 feet long and in the form of a circle, the angle of the floor plate where it is connected to the side tubes will only about 30 degrees. This angle would generate a tension of only about 1261 pounds in the one inch wide section of the floor plate carrying a one inch wide slice of the load.

However, because there will always be more load concentrated in the center of the dump body floor, the angle of the plate where it is connected to the side tubes could approach 45 degrees. Such an angle would generate a tension in the plate of about 1556 pounds or a stress in the plate if it was one inch thick of 1556 pounds per square inch. The strength of the steel in of most conventional truck body floors is over 100,000 lb/in2. If the same strength steel were used for the truck shown in FIGS. 15-17, and using a conventional three to one safety factor, the disclosed dump body floor can be safely stressed to 33000 lb/in2. This means that if the disclosed truck were loaded with sand using a conveyor, the floor need only be about 0.05 inches thick. Such a dump body floor, sixty feet long, would weigh only about 5000 pounds and easily carry an 800 ton load.

However, if the disclosed floor were made with a 0.5 inches thick with a thirty to one safety factor to take impact loading from a 100 ton shovel, the overall floor weight would be similar to conventional dump bodies that only carry less than half the volume and half the load. With no points of stress concentrations due to the catenary configuration, a long, trouble-free life can be expected with the floor plate of the disclosed dump body.

The front of the dump body is closed in two horizontal beams connecting the two sides of the body and will absorb the horizontal forces generated by the floor plate. In the rear of the body, which must remain open, there are two tilt pins on each side of the body spaced wide apart. They are mounted on and extend from the heavily constructed lateral strut support beam of the dump body. These pins react against the horizontal forces generated on top of the body by the floor plate. Another advantage of this dump body is that it will be a smooth surfaced, corner free floor. This construction will eliminate both material sticking to the floor and, when during cold weather, material freezing to the floor. The smooth surfaces will generally not retain material and will not need to be heated.

The above-disclosed trucks include or provide many important features that result in the advantageous design. These include means to control the motors, to get power to the motors, to cool the motors, to monitor the motors, to actuate the parking brakes, to actuate the service brakes, to cool the brakes, to rotate the suspension power module 210 degrees, to steer the truck in its many modes, and to allow the suspension 30 inches or more of travel. One exemplary feature used to fulfil these requirements is accomplished by the routing and arrangement of the many hoses and lines to the struts as shown in FIG. 17.

In this example, two water hoses, two hydraulic lines, four D.C. electric lines, one electric ground line, and one line or conduit containing monitoring and control lines are stacked one above the other. In the disclosed routing, the multiple lines can remain within 12 inches of the diameter of the steering cylinders. The lines are positioned on the opposite side of the strut using the same vertical space. On the strut steer tube there are two vertical cylinder segments arranged tangent on the opposite side of the stack of lines. The radius of these cylinder segments is appropriate for the largest dynamic bend radius of the lines.

The lines extend out to a similar cylinder which is mounted on a horizontally rotatable spring loaded arm. The arm is mounted on a portion of the frame of the truck. This spring loaded arm retains tension on the stack of lines as the steer tube rotates left and right, for example, 120 degrees in one direction and 90 in the other. On the inside of these vertical cylinder segments, the lines change direction and wrap around a horizontal cylinder segment that is mounted to the steer tube. From there the lines extend out to a rotatable cylinder that is mounted on a spring loaded arm to keep tension on the lines. The arms are mounted at the center line of the horizontal cylinder segment. From there the lines run to another horizontal cylinder segment that is mounted on the spindle between the tires. From this point, each line runs to its appropriate location and component.

The input water line or hose runs to a flow divider. From the flow divider, water is delivered separately to each of the A.C. motor control boxes. From the motor control boxes, the water is delivered to cool each of the motors. From each of the motors, the water is routed to the heat exchangers that cool the oil from disc brakes. From the heat exchangers, the water is teed back to a single line and routed back to an air cooled radiator and a water pump.

The location of the motor control boxes and heat exchanger for the brakes, mounted to the spindle, between the tires is quite unique. The routing of the electric lines an the cooling lines to the motors is also quite unique. The protective shielding of these components is very important and also unique.

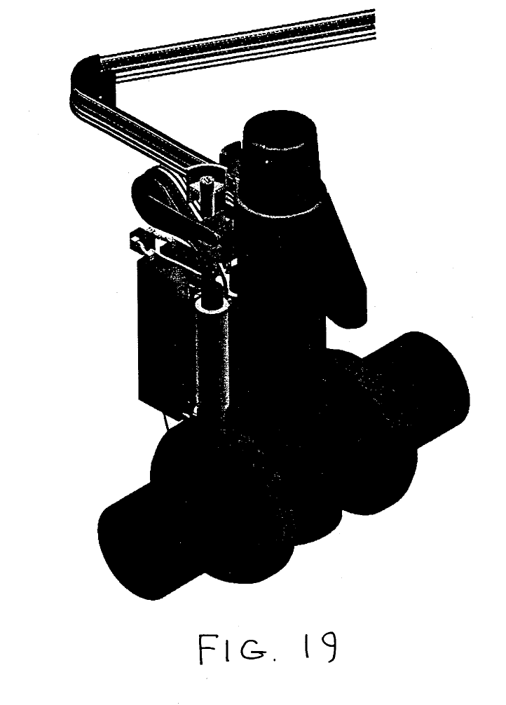

In the disclosed example shown in FIGS. 18 and 19, there is one steer cylinder for each strut module. The following is an example to explain the principles of the disclosed strut module. The turning angle of each of the strut modules to enable all tires be turning about the same point (to eliminate tire scrubbing) can be determined by a computer. The computer can obtain and determine its necessary data by knowing the extension of the steer cylinder. This can be done utilizing linear displacement transducers located inside each cylinder. A similar device can be positioned outside each cylinder to measure the angle of the cylinder body relative to the frame. The device determines when the steer cylinder is over center, and also in what direction a steering force should be applied. The computer can send a signal to a hydraulic valve which in turn can be operated to deliver oil to the steer cylinders as required.

The computer can also send a signal to each of the A.C. motor speed control boxes so that each motor will turn at a speed relative to the corresponding wheel's distance from the turning point of the truck. When fully extended, each cylinder, in one example, can rotate the strut module 90 degrees. For the same degree of steering force in the opposite direction, each cylinder can rotate the strut module 51 degrees, for example. At that sharp of an angle, the truck will be moving very slowly to permit the motors and cylinders to easily reach the desired parameters. At 65 degrees, for example, each steer cylinder will be over center and beyond the center of the steer tube. Somewhere between 51 degrees and 65 degrees, the motor speed control system, which can control the speed of the motor within one percent, will have more influence in positioning the angle of the strut module than the steer cylinder. This will allow a strut module on the inside of a turn to rotate 120 degrees allowing the truck to rotate about its center without the truck actually moving in any direction, or to rotate 90 degrees allowing all the tires to be parallel so that the truck can move straight sideways.

Other alternative embodiments can include front strut modules that turn as described above but do not drive any of the front wheels or at least not all of the front wheels. The rear wheels in such an example can be driven as described above but not turned. Each independent drive motor of each driven wheel can be controlled as above to eliminate tire scrubbing.

The foregoing detailed description has been given for clearness of understanding only and no unnecessary limitations should be understood therefrom, as modifications would be obvious to those of ordinary skill in the art.

What is claimed is:

1. A truck comprising:
a frame defining a longitudinal axis of the truck;
a forward strut support coupled to the frame and oriented laterally relative to the longitudinal axis;
first and second strut modules coupled to the forward strut support near respective opposite ends of the forward strut support;
a rear strut support coupled to the frame and oriented laterally relative to the longitudinal axis;
third and fourth strut modules coupled to the rear strut support near respective opposite ends of the rear strut support, wherein each of the strut modules is steerable and each of the strut modules includes a tire mounted thereon; and
a cab located forward of and centrally relative to the forward strut support.

2. A truck according to claim 1, further comprising:
a material receiving container carried by the frame and pivotable between a transport position and a dump position; and comprising:
a pair of dump cylinders for raising and lower the container to and from the dump position, each of the dump cylinders coupled to opposite sides of the container and one each to one of the opposite ends of the forward strut support.
